(19) United States
(12) Patent Application Publication
(10) Pub. No.: US 2026/0079268 A1
(43) Pub. Date: Mar. 19, 2026

(54) METHOD FOR LOCATING A MACHINE ON A PREDEFINED PATH, ASSOCIATED COMPUTER PROGRAM AND DEVICE

(71) Applicant: GTS FRANCE, VELIZY-VILLACOUBLAY (FR)

(72) Inventors: Jeffrey YU, VELIZY-VILLACOUBLAY (FR); Loïc BOYER, VELIZY-VILLACOUBLAY (FR); Philippe LAVIRON, VELIZY-VILLACOUBLAY (FR)

(21) Appl. No.: 19/327,841

(22) Filed: Sep. 12, 2025

(30) Foreign Application Priority Data
Sep. 16, 2024 (FR) 2409830

(51) Int. Cl. G01S 19/50; G01S 19/20; G01S 19/28; G01S 19/37

(52) U.S. Cl. CPC G01S 19/50; G01S 19/20; G01S 19/28; G01S 19/37

(57) ABSTRACT

A method for locating a train moving over a set of tracks over which are distributed virtual beacons defined by their geographical coordinates, the train being equipped with an on-board satellite receiver that receives geopositioning signals from satellites S₁, . . . ; Sₛ for each beacon Bj, j=1 to N and each satellite Sk, k=1 to s: the correlation delay, X(Sₖ, Bⱼ), between the geopositioning signal received by the satellite receiver from Sk and the theoretical geopositioning signal that should, according to computations, have been received from Sk for Bj is computed; a value representative of the correlation delay X(Sₖ, Bⱼ) is converted into a distance, ΔS_{Bj,Sk}, by multiplying this representative value by c and dividing it by the cosine of the elevation elₖ of Sk; then MSB_{Bj}=MAX_{k=1 to s}{ΔS_{Bj,Sk}} is determined then the MSB_{Bj}, j=1 to N, are compared with a predefined threshold MSB_{REF}: according to this comparison, if only one beacon has a maximum spatial bias MSB_{Bj} less than MSB_{REF}, this beacon is then detected as the one at which the train is to be found.

### CROSS-REFERENCE TO RELATED APPLICATION

This application claims priority to foreign French patent application No. FR 2409830, filed on Sep. 16, 2024, the disclosure of which is incorporated by reference in its entirety.

### FIELD OF THE INVENTION

The present invention relates to the field of estimation of position through satellite geopositioning via a GNSS (abbreviation of Global Navigation Satellite System).

### BACKGROUND

There are 2 categories of GNSS positioning: absolute positioning, where location is obtained using only GNSS pseudoranges and no external information, and differential or relative positioning, where positioning is achieved with respect to a reference (ground reference stations). The latter includes solutions such as precise point positioning (PPP), real-time kinematics (RTK), and using a satellite-based augmentation system (SBAS).

To achieve the required level of safety integrity level, SIL4, it is currently required to have infrastructure (including real beacons) on the ground.

The applicant previously developed a positioning solution based on computation of a correlation between a received GNSS signal and PRN codes predicted for the known positions of georeferenced virtual beacons: without errors, a correlation of maximum power should be observed for the position hypothesis closest the receiver, allowing the possible positions of the virtual beacons closest the receiver to be detected.

The absolute accuracy of a position obtained by a position-determining system, conventionally by triangulation of data generated by satellites and received by a satellite receiver, is decreased by errors that may be expressed and summed as follows:

UERE²=(E__{SIS})²+(E__{Tropo})²+(E_ₗₒₙₒ)²+(E__{Rx})²+(E__{Multipath})² where
UERE is the user equivalent range error;
E__{SIS} represents signal-in-space errors, i.e. errors related to satellite transmission (satellite clock, path, etc.);
E__{Tropo} and E_ₗₒₙₒ are errors related to interference due to reflection of the signal in space from the troposphere and ionosphere, respectively;
E__{Rx} are errors generated in the satellite receiver, typically due to receiver measurement noise, phase centre and clock bias;
E__{Multipath} are errors due to reflection of the satellite signal from obstacles before reaching the satellite receiver.

Positioning error may be modelled and therefore estimated under the assumption that all the satellites are transmitting correctly and based on signal-to-noise ratio (SNR); however, the obtained value is a statistical value.

The types of errors in the satellite-receiver link are also classified as follows, depending on where they occur:
“satellite” errors, due to: clock drift (desynchronisation), orbit description (ephemerides), and phase centre (antenna polarisation);
“propagation” errors, due to: ionospheric delay (layer of the atmosphere at an altitude of approximately 80 to 1000 km, effects related to the presence of free charge carriers), and tropospheric delay (layer at an altitude of 0 to approximately 80 km, effects mainly related to meteorological conditions);
“reception” errors, due to: measurement noise, phase centre, and clock bias;
“local” errors due to: multi-path, and spoofing.

There is a need to provide a reliable locating solution applicable in particular to the constraints of the railway sector.

### SUMMARY OF THE INVENTION

According to a first aspect, the present invention describes a method for locating a machine configured to move over a set of one or more predefined paths,
a satellite receiver located on board the machine being configured to receive, at a time t, geopositioning signals from a system of satellites comprising at least s satellites Sk, k=1 to s and s greater than or equal to 3;
an electronic processing unit comprising a database storing the geographical coordinates Pj of virtual beacons Bj, j=1 to N, distributed along the paths of said set of one or more paths;
said method comprising the following steps implemented by the electronic processing unit at a locating time t:
   i1/ for each beacon Bj, j=1 to N:
      for each satellite Sk for k=1 to s:
         computing the delay between the geopositioning signal received by the satellite receiver at the time t from satellite Sk and the theoretical geopositioning signal that should, according to computations, have been received from satellite Sk at the time t at the position of virtual beacon Bi such as defined by the geographical coordinates Pj of Bj in the database, said delay being called the correlation delay, X(Sₖ, Bⱼ);
         a value representative of the correlation delay X(Sₖ, Bⱼ) is converted into a corresponding distance, ΔS_{Bj,Sk}, called the spatial bias, by multiplying this value representative of the correlation delay X(Sₖ, Bⱼ) by c, the speed of light in vacuum, and dividing it by cos elₖ, where elₖ is the elevation of satellite Sk;
      for each beacon Bj, j=1 to N, a maximum spatial bias MSB_{Bj} is determined:

$${MSB}_{BJ} = {MAX}_{k = 1 to s} \{ Δ {S}_{Bj , Sk} \}$$

i2/ the maximum spatial biases MSB_{Bj}, j=1 to N, are compared with a predefined threshold MSB_{REF}: according to this comparison, if only one beacon has a maximum spatial bias MSB_{Bj} less than MSB_{REF}, this beacon is then detected as the one at which the machine is to be found at the locating time.

The proposed innovation uses the principle of correlation with estimation of the best position based on measurements of the correlation delay. This approach thus makes it possible to guarantee independent integrity of the measurement, i.e. without additional sensors or installations other than the GNSS receiver, and is thus perfectly suitable for rail navigation.

The advantage of using correlation delays rather than identifying the closest beacon as being the one maximizing correlation power (for example via

$$Arg {max}_{{B}_{j}} ( \frac{1}{s} {\sum }_{k = 1}^{s} {Corr ( {S}_{k} , {B}_{j} , t )}^{2} )$$

where Corr(Sₖ, Bⱼ, t)² is the maximum power of the correlation signal) is that the bias due to the fact that the level of correlation depends on the received power is avoided because correlation delay is independent thereof.

The invention therefore provides a reliable positioning solution that allows errors to be reduced and it further takes into account a protection radius defining a maximum tolerable accuracy error limit.

In some embodiments, such a method will furthermore comprise at least one of the following features:
one of the following measures is further implemented by the processing unit in step i2:
i2_1/ if only two beacons have their maximum spatial biases less than MSB_{REF} and they are adjacent on the same track, it is considered that the machine is between the two beacons;
i2_2/ if more than one beacon has a maximum spatial bias less than MSB_{REF} (optionally excluding the case just above): an ambiguous situation is detected and it is considered that location is not possible;
i2_3/ if only two beacons have their maximum spatial bias less than MSB_{REF} and they are adjacent on the same track, it is considered that the machine is to be found between the two beacons; excluding this case, if more than one beacon has a maximum spatial bias less than MSB_{REF}, it is considered that location is not possible;
i2_4/ if no beacon has a maximum spatial bias MSB_{Bj_pos} less than MSB_{REF}, this indicates the existence of defective satellites, an ambiguous situation is thus detected and it is considered that location is not possible;
steps i1 and i2 are iterated relative to each subset of satellites containing s−1 of the s satellites instead of the s satellites considered in the previous iteration for s≥5, when, according to said comparison of the previous iteration, only one beacon has a maximum spatial bias MSB_{Bj} less than MSB_{REF} and
if, in the current iteration, for each of the subsets of satellites, the comparing step detects the same single beacon as the previous iteration, corresponding to a given integrity level, said beacon is considered to be detected with said given integrity level increased by one;
steps i1 and i2 are iterated relative to each subset of satellites containing s−1 of the s satellites instead of the s satellites considered in the previous iteration for s≥5, and if in the previous iteration, no beacon had a maximum spatial bias MSB_{Bj_pos} less than MSB_{REF} and in the current iteration, a single beacon has a maximum spatial bias MSB_{Bj} less than MSB_{REF}, this beacon is then detected as the one at which the machine is to be located at the locating time and the sth satellite is identified as faulty;
said value representative of the correlation delay X(Sₖ, Bⱼ) is equal to the difference between said correlation delay X(Sₖ, Bⱼ) and a bias, called BC_{Bj}, that is an estimate of the temporal bias associated with beacon Bⱼ and common to all the satellites and allowing MSB_{Bj} to be minimized;
said value representative of the correlation delay X(Sₖ, Bⱼ) is equal to the difference between said correlation delay X(Sₖ, Bⱼ) and a bias called

$${BC}_{Bj} = \frac{1}{s} {\sum }_{k = 1}^{s} X ( {S}_{k} , {B}_{j} ) ;$$

the processing unit implements one of the following measures i1a, i1b, i1c, in order, considering beacon Bi, to implement step i1 of computing delays, X(Sₖ, Bᵢ, t) for k=1 to s:
i1a/ computing the correlation between said received geopositioning signal and said theoretical geopositioning signal computed for Bᵢ, said delay X(Sₖ, Bᵢ, t) being computed depending at least on said computed correlation;
i1b/ the delay X(Sₖ, Bᵢ, t) is computed by translation, using the following formula:

$$X ( {S}_{k} , {B}_{i} , t ) = X ( {S}_{k} , {B}_{0} , t ) + \frac{1}{c} ( {S}_{k} {B}_{i} - {S}_{k} {B}_{0} ) ,$$

where SₖB₀ and SₖBᵢ are the distance between satellite Sₖ and a reference beacon B₀, and the distance between satellite Sₖ and beacon Bᵢ, respectively,
X(Sₖ, B₀, t) is the delay between the geopositioning signal received by the satellite receiver at the time t from satellite Sₖ and the theoretical geopositioning signal that should, according to computations, have been received from satellite Sₖ at the time t at the position of virtual beacon B₀ such as defined by the geographical coordinates P0 of B₀ in the database
c is the speed of light in vacuum;
i1c/ the delay X(Sₖ, Bᵢ, t) is computed by translation, using the following formula:

$$X ( {S}_{k} , {B}_{i} , t ) = X ( {S}_{k} , {B}_{0} , t ) + ds * cos ( {el}_{k} ) / 0.3$$

where B₀ is a reference beacon,

$$\begin{matrix}Δ la = latitude ( {B}_{0} ) - latitude ( {B}_{i} ) , Δ lo = longitude ( {B}_{0} ) - longitude ( {B}_{i} ) α = arctan ( Δ la / ( Δ lo \\ * cos ( latitude ( {B}_{0} ) ) ) \\ β = {az}_{k} + α \\ ds = d * sin ( β )\end{matrix}$$

where latitude( ), longitude( ) are coordinates in an orthogonal coordinate system in the local tangent plane;
the processing unit implements at least one of the following measures 4.1, 4.2:
   4.1 by implementing measure i1a, X(Sₖ, B₀₁, t) and X(Sₖ, B₀₂, t) are computed; then, considering B₀₁ as reference beacon and implementing one of the formulas in i1b or i1c, the delay for B₀₂ is determined this time by translation considering B₀₁ as reference beacon and is called X(Sₖ, B₀₂, t)₀₁;
   and, depending at least on the difference between X(Sₖ, B₀₂, t) and X(Sₖ, B₀₂, t)₀₁, the satellite Sₖ is excluded from the set of satellites taken into consideration for step i3 of estimating the location of the machine depending on said values representative of discrepancies between said computed delays;
   4.2 performing the following step for beacons Bi, i=1 to r:
   by implementing one of the formulas in i1b or i1c: a first delay X(Sₖ, Bᵢ, t)₀₁ is determined considering B₀₁ as reference beacon and a second delay X(Sₖ, Bᵢ, t)₀₂ is determined considering B₀₂ as reference beacon;
   and, depending at least on the differences between X(Sₖ, Bᵢ, t)₀₁ and X(Sₖ, Bᵢ, t)₀₂, i=1 to r, the satellite Sₖ is excluded from the set of satellites taken into consideration for step i3 of estimating the location of the machine depending on said values representative of discrepancies between said computed delays;
each beacon considered is spaced apart from its nearest neighbours by a distance D equal to the distance between two neighbouring tracks and the predefined threshold MSB_{REF} is set equal to D/2.

According to another aspect, the invention describes a computer program intended to be stored in the memory of an electronic device further comprising a microcomputer, said computer program comprising instructions that, when they are executed on the microcomputer, implement the steps of a method according to the invention.

According to another aspect, the invention describes an electronic processing unit for locating a machine that is configured to move over a set of one or more predefined paths and that has on board it a satellite receiver for receiving, at a time t, geopositioning signals from a system of satellites comprising at least s satellites Sk, k=1 to s and s greater than or equal to 3;
the electronic processing unit comprising a database storing the geographical coordinates Pj of virtual beacons Bⱼ, j=1 to N, distributed along the paths of said set of one or more paths;
said electronic processing unit being configured to implement the following operations, at a locating time t:
i1/ for each beacon Bj, j=1 to N:
for each satellite Sk for k=1 to s:
computing the delay between the geopositioning signal received by the satellite receiver at the time t from satellite Sk and the theoretical geopositioning signal that should, according to computations, have been received from satellite Sk at the time t at the position of virtual beacon Bi such as defined by the geographical coordinates Pj of Bj in the database, said delay being called the correlation delay, X(Sₖ, Bⱼ);
a value representative of the correlation delay X(Sₖ, Bⱼ) is converted into a corresponding distance, ΔS_{Bj,Sk}, called the spatial bias, by multiplying this value representative of the correlation delay X(Sₖ, Bⱼ) by c, the speed of light in vacuum, and dividing it by cos elₖ, where elk is the elevation of satellite Sk;
for each beacon Bj, j=1 to N, a maximum spatial bias MSB_{Bj} is determined:

$${MSB}_{Bj} = {MAX}_{k = 1 to s} \{ Δ {S}_{Bj , Sk} \}$$

i2/ the maximum spatial biases MSB_{Bj}, j=1 to N, are compared with a predefined threshold MSB_{REF}: according to this comparison, if only one beacon has a maximum spatial bias MSB_{Bj} less than MSB_{REF}, this beacon is then detected as the one at which the machine is to be found at the locating time.

### BRIEF DESCRIPTION OF THE DRAWINGS

The invention will be better understood and other features, details and advantages will become more clearly apparent on reading the non-limiting description that follows, and by virtue of the appended figures, which are given by way of example.

FIG. 1 schematically shows a railway system implementing one embodiment of the invention;

FIG. 2 shows steps of a position-determining method 100 in one embodiment of the invention;

FIG. 3 illustrates the relationship between temporal bias ΔT_{Bj,Sk} (=X(Sₖ, Bⱼ, t)) and spatial error ΔS_{Bj,Sk};

FIG. 4 shows the values taken by a correlation function in one example;

FIG. 5 shows steps of a position-determining method 100 in one embodiment of the invention;

FIG. 6 illustrates the geometric model considered;

FIG. 7 also illustrates the geometric model considered;

FIG. 8 shows a local tangent coordinate system used in one of the embodiments of the invention;

FIG. 9 illustrates the determination of spatial biases for a beacon such as considered in step 105;

FIG. 10 illustrates the correction of common bias for a beacon and the maximum spatial bias determined for the considered beacon in step 105;

FIG. 11 is a flowchart defining the sequence of TESTS 1, 2 and 3 in one embodiment of the invention;

FIG. 12 shows “correlation lines”;

FIG. 13 illustrates beacons grouped into paths in one embodiment of the invention;

FIG. 14 schematically shows a processing operation performed in the case of a moving train (case said to be dynamic).

Identical references may be used in various figures to designate identical or comparable elements.

### DETAILED DESCRIPTION

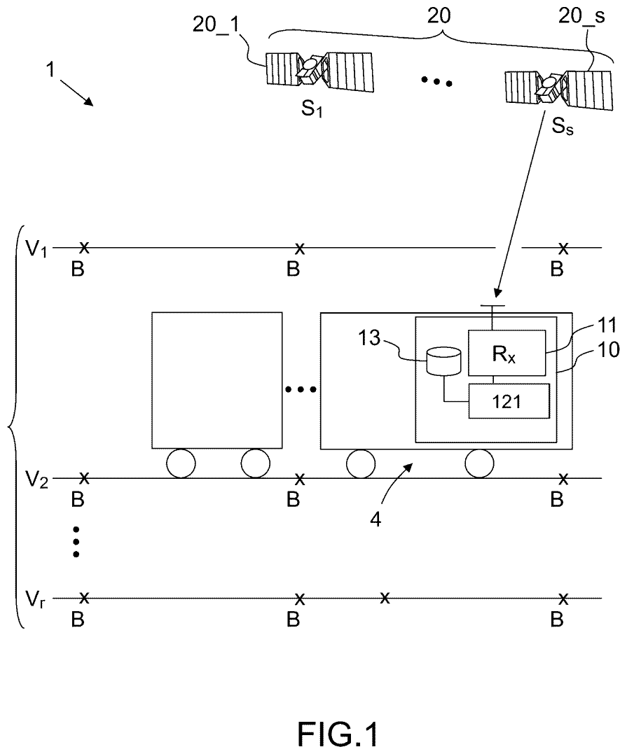

With reference to FIG. 1, a railway system 1 in one embodiment of the invention comprises one or more trains, including the train 4 shown in FIG. 1, that are configured to move over a predefined path or various predefined paths. Each of these paths is represented by a sequence of track segments (for example, left or right rail segments, or even-virtual-segments placed between the right and left rails, etc.).

The train 4 comprises an on-board electronic processing unit 10, which comprises:
a unit Rₓ 11 comprising a standard GNSS satellite global positioning system;
an electronic locating unit 121;
a topographic database 13.

In FIG. 1, segments of r respective tracks V₁, V₂, . . . , Vᵣ have been shown.

Below, a predetermined position, or reference point, the spatial coordinates of which are known with precision will be called a “virtual beacon” or “beacon”, B. The beacons are distributed over the track segments, for example on the line centred between the 2 track rails, or in proximity to the track, and for example at less than 50 cm from this line.

For example, the distance between two neighbouring tracks being equal to D, the beacons are spaced apart from their beacons nearest thereto on the same track by a distance equal to D, with D here equal to 4 m for example (in other embodiments, this distance is less than 4 m, and for example equal to 2 m).

The track segments, and the beacons, are finite in number. Their 3D geographical position (with respect to a terrestrial reference frame) and their characteristics are known and are referenced in the topographic database 13. These characteristics for example comprise: segment identifier, beacon identifier, segment length, heading of the segment (also called route heading), association between segment identifier and identifier of the beacons located on (or in immediate proximity to) the segment, value of geometrical parameters (for example Euler spiral or spline), characteristics of sequences in the railway network (for example: identifier of successor and predecessor segments).

The unit Rₓ 11, located on board the train 4, is configured to receive, in a synchronized local time base, geopositioning signals sent by a set 20 of GNSS geopositioning satellites: S₁ 20_1, . . . , Sₛ 20_s, visible to the unit Rₓ 11. Depending on the embodiment, s=1 or s≥Nsat, with Nsat equal to 2, 3, 4 or 5.

The GNSS satellites for example comprise satellites of the US system GPS (GPS standing for Global Positioning System) and/or of the European system GALILEO and/or of the Russian system Glonass, and/or of the Chinese system BeiDou or any other equivalent system. The positions, which may change over time, of the satellites are predetermined and known to the receiver Rₓ 11 (via ephemeris data).

In a known manner, the GNSS receiver in the unit Rₓ 11 is configured, given the received signals, to downshift frequency to baseband, to demodulate the signal and to extract therefrom a geopositioning signal comprising the repetition of a code at 1023 Hz. It is this signal in this form that will be denoted the “received signal” below, and that is used, for example for the correlation computations.

For example, in a known manner, the GNSS receiver is further configured to extract time and PRN-code delay information (PRN standing for Pseudo Random Noise, which is used in Galileo and GPS) and to compute, for each satellite in sight, based on this received information, an estimate of the distance between the geolocation device itself and the satellite in sight, which estimate is also called pseudorange.

The pseudorange is different from the actual distance between the satellite considered and the geolocation device because of the aforementioned errors in estimating propagation time, due for example to atmospheric conditions in the troposphere and in the ionosphere, and to the synchronization error of the internal clock of the geolocation receiver. However, it is possible using information transmitted by a plurality of separate satellites to eliminate common errors (including receiver time bias).

For example, the PRN code of the C/A signal (C/A standing for Coarse Acquisition) in the GPS case is a digital signal composed of 1023 chips that repeats every millisecond. It will be noted that the term “chip” used in GNSS techniques is to be distinguished from the term “bit”, which is used to define a unit of information. The code has a given code length, called L(C/A). Its temporal length is 1 ms, and therefore its spatial length is 1 ms*c where c is the speed of light. A chip temporal length of 1 ms/1023 is deduced therefrom.

The locating unit 121 is configured to estimate the position of the train 4 considered at the time t.

Depending on the embodiment, this estimation of location takes different forms. For example, in one embodiment, it comprises determining the position of the beacon estimated to be closest to the train 4 and/or the geographical coordinates of the receiver Rₓ; in one embodiment it allows a previously determined positioning hypothesis to be validated or invalidated; and in one embodiment it allows the track segment on which the train is in principle positioned to be determined (specifically, being certain of the track on which the train is positioned is a major factor in safety, allowing accidents to be avoided).

Location is estimated, according to the invention, in particular based on the satellite positioning signals received by the unit Rx 11 in its position to be estimated, and furthermore, in some embodiments, based for example on measurements from an on-board inertial measurement unit and/or based on measurements taken by an odometer.

Method for determining position, according to the invention, depending on correlations between predicted signals relating to virtual beacons and received signals.

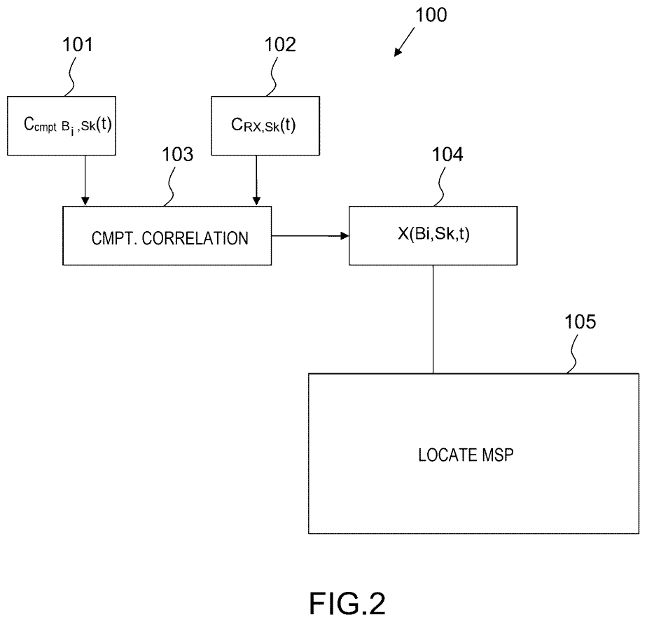

With reference to FIG. 2, a method 100 for determining the position of the train 4 at the time t is implemented by the processing unit 10; it comprises a set of steps 101 to 105 in which the received GNSS signal and prior knowledge of the positions of the fixed and predetermined virtual beacons B, which knowledge is obtained the topographic database 13, are exploited.

Such a method exploits the fact that the path of the train 4 necessarily follows the railway track segments, which are known and on which the beacons feature.

The processing involves correlation of the GNSS signal received, by the unit Rₓ 11, at the local reference date t of the GNSS receiver, from the various visible satellites Sₖ, k=1 to s (s being, depending on the embodiment, the maximum number of available satellites or a subset), with each of the code signals expected (replica code signals) from these satellites at the same local reference date t of the GNSS receiver, and computed for the position Pᵢ of a virtual beacon Bᵢ.

Depending on the case, the beacons considered Bᵢ, i=1 to N, are all the beacons B, or else a strict subset of this set of beacons B (therefore containing a lower number of beacons determined taking into account certain basic assumptions considered known: train 4 located on a passing siding or departure track or running line, in a restricted geographical area, etc.). The beacon Bᵢ is located at Pᵢ, a 3D geographical position provided, in association with Bᵢ, in the database 13.

In one embodiment, the processing unit 10 comprises a processor, and a memory in which are stored software instructions that, when they are executed on the processor, implement the steps of the method 100.

Thus, in step 101, the signals theoretically received (replica signals) at the time t by each considered beacon Bᵢ, c_{cmpt Bi,Sk}(t), from each satellite Sₖ in sight of the beacon are predicted by the locating unit 121 (as the position of the beacon is known the travel time of the satellite signal to the beacon is known).

In the generation of the local GNSS replicas of the expected codes, errors are taken into account using available error models, i.e. known models of clock error, ionospheric error and tropospheric error. These error models may be delivered by the on-board GNSS receiver or via an assistance link, and allow errors in the expected distances of the satellites to be decreased to a few metres.

It is assumed that the residual errors in the code delay after application of the corrections are described by centred Gaussians (in one embodiment, the validity of this assumption is then tested in an integrity demonstration).

In step 102, at the time t, the unit Rx 11 receives, in its current position, the signals C_{RX,Sk}(t) sent by the satellites Sₖ, k=1 to s, and delivers them to the locating unit 121.

In step 103, for beacon Bi and each satellite Sₖ, the correlations between predicted signals c_{cmpt Bi,Sk}(t) and signals C_{RX,Sk}(t) received at the time t by the unit Rx 11 are computed by the locating unit 121.

The correlation functions are computed for beacon Bᵢ and for satellite Sₖ—at least for a certain number of values of τ:

$${Γ}_{Bi}^{Sk} ( τ ) = \int {c}_{RX , k} ( t ) \cdot {c}_{cmpt Bi , k} ( t - τ ) \cdot d τ$$

(the integration interval is for example set to the value T, which is typically equal to at least the duration of one navigation bit, i.e. 20 ms, or 20 PRN code lengths).

In step 104, for beacon Bᵢ and for satellite Sₖ, the locating unit 121 then estimates the value of τ for which the correlation function

$${Γ}_{Bi}^{Sk} ( τ )$$

is maximum; this value, which is the correlation delay between the two signals c_{cmpt Bi,Sk}(t) and C_{RX,Sk}(t), is called X(Sₖ, Bᵢ, t).

The code delay X(Sₖ, Bᵢ, t) thus obtained is in fact composed of a term for propagation error and residual error, and of a geometric term depending on the distance between the beacon and the receiver, and on the azimuth and elevation of the satellite considered.

In step 105, depending on the code delays thus estimated X(Sₖ, Bᵢ, t) at the time t considered for the beacons considered Bᵢ, i=1 to N, and for the satellites considered Sₖ, k=1 to s: the locating unit 121 estimates the location of the train 4, in the manner described below, which is called the MSP solution (MSP standing for Maximum Spatial Protection), after the presentation of details relating to the geometric model and measurement model employed by this solution.

Example of determining position when the train is stationary, on a stabling or departure track (case referred to as static):

In such a case, for example, only beacons that are identified in the database 13 as being located on segments of stabling tracks or departure tracks (or a subset of these beacons) are considered when implementing the algorithm 100. These subsets of beacons are therefore, in this case, the beacons Bᵢ, i=1 to N.

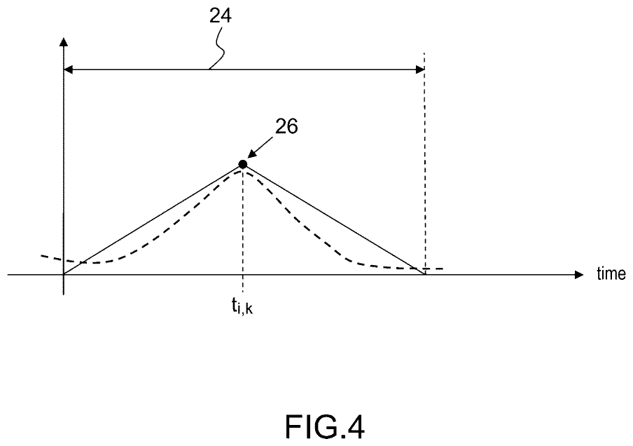

FIG. 4 shows a one-dimensional graphical representation, as a function of time (represented on the x-axis), of a correlation function such as mentioned above, the correction function having been shown schematically as a triangle, even though in fact, as a result of noise, it will be more like a dashed curved, which may be considered to be a parabola (parabolic interpolation) in the region of the apex 26.

The duration 24 is typically the duration of a chip of a GNSS code sequence (typically for GPS a chip corresponds to 1 μs, i.e. 300 m).

This correlation function has a maximum 26, as defined, of x-coordinate tik, which is therefore the code delay. In embodiments, an interpolation is further performed to better estimate the position of the maximum.

In embodiments, when computing the values of the correlation function for beacon Bᵢ and satellite Sₖ, i=1 to N and k=1 to s, the following steps are carried out (in particular using three multiplier modules and three integrator modules):
a convolution product is determined: the received satellite signal C_{RX,k}(t) is multiplied by the replica signal c_{cmpt Bi,k}(t)—which replica is in principle perfectly aligned with the code (if the train is positioned at Pi and in the absence of uncompensated errors)—then the result is integrated: the output value, called Prompt (P), is representative of the correlation between these two signals;
the received satellite signal C_{RX,k}(t) is multiplied by the advanced replica signal c_{cmpt Bi,k}(t+δ), then the result is integrated: the output value, called Early (E), is representative of the correlation between these two signals; for example, the value δ, which is positive, is for example equal to 7.5 ns (the idea being to obtain a predefined Early-Late interval that is representative of the need for precision, in particular regarding track detection; since the tracks are considered to be spaced apart by 4 m, i.e. 15 ns in the time domain, a gap of 15 ns between the Early and Late points is for example chosen here).
the received satellite signal C_{RX,k}(t) is multiplied by the delayed replica signal c_{cmpt Bi,k}(t−δ), then the result is integrated: the output value, called late (L), is representative of the correlation between these two signals;
in embodiments, in order to obtain more points of the correlation function, additional replica signals that are advanced and delayed by shifts δ1, δ2, are for example also multiplied and integrated.

Below, the Doppler shift is considered to be perfectly known.

### Geometric Model

The correlation delay X(Sₖ, Bⱼ, t) corresponds to the code delay measured between the signal received by the receiver Rₓ from satellite Sₖ and the signal predicted for a beacon Bⱼ.

In the absence of propagation error, satellite error, receiver error and local errors, X(Sₖ, Bᵢ, t) is therefore the difference in trip time between the satellite-beacon trip and the satellite-receiver trip.

Then

$$X ( {S}_{k} , {B}_{j} , t ) = \frac{1}{c} ( {S}_{k} {B}_{j} - {S}_{k} {R}_{x} )$$

for satellite Sₖ and beacon Bⱼ. With geometric considerations, this relationship may be expressed to the first order as a function of the distance between the receiver and the beacon.

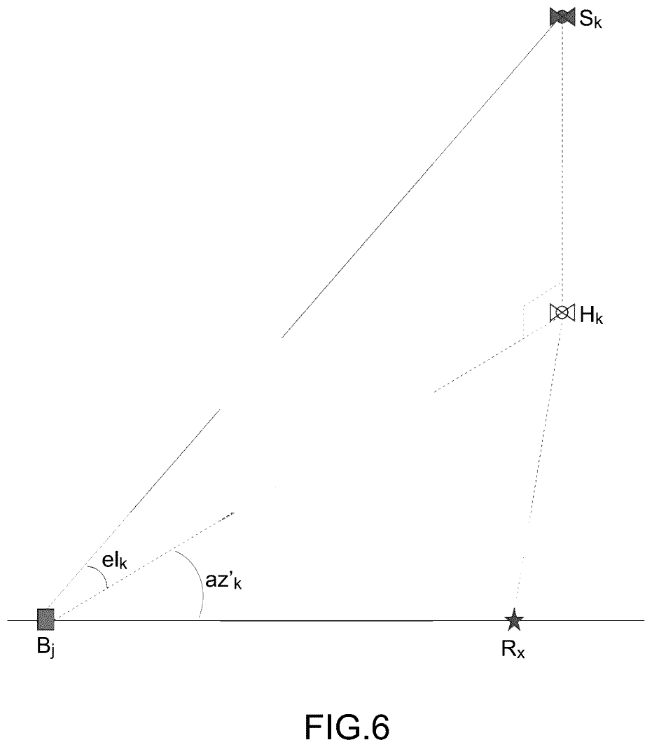

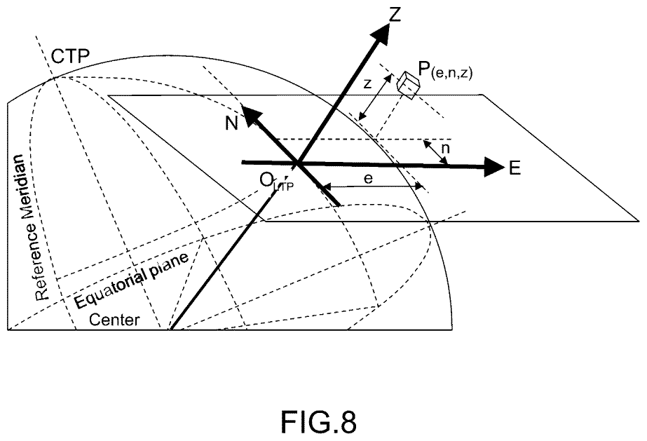

With reference to FIG. 6, and using the following terms:
Hₖ the orthogonal projection of the position of Sₖ in the local plane tangent to the Earth at the place considered (for example associated with the NED coordinate system (NED standing for North, East, Down) or ENU coordinate system (ENU standing for East (E), North (N), Up (Z): see FIG. 8),
elₖ the elevation of satellite Sₖ and azₖ′ the relative azimuth of satellite Sₖ with respect to the line between the beacon Bj and the receiver Rₓ,
   the following is obtained:

$$X ( {S}_{k} , {B}_{j} , t ) = \frac{1}{c} ( {S}_{k} {B}_{j} - {S}_{k} {R}_{x} ) = \frac{{H}_{k} {B}_{j} - {H}_{k} {R}_{x}}{c \cdot cos ( {el}_{k} )}$$

c being the speed of light in vacuum.

By applying the law of cosines to the triangle HₖBₖRₖ the following is obtained:

$$\begin{matrix}{H}_{k} {R}_{x} = \sqrt{{H}_{k} {B}_{j}^{2} + {R}_{x} {B}_{j}^{2} - 2 \cdot cos ( {az}_{k}^{′} ) \cdot {H}_{k} {B}_{j} \cdot {R}_{x} {B}_{j}} \\ {H}_{k} {R}_{x} = {H}_{k} {B}_{j} \sqrt{1 + \frac{{R}_{x} {B}_{j}^{2}}{{H}_{k} {B}_{j}^{2}} - 2 \cdot cos ( {az}_{k}^{′} ) \cdot \frac{{R}_{x} {B}_{j}}{{H}_{k} {B}_{j}}}\end{matrix}$$

The radical may be developed to the first order, giving:

$${H}_{k} {R}_{x} \approx {H}_{k} {B}_{j} - cos ( {az}_{k}^{′} ) \cdot {R}_{x} {B}_{j}$$

and now considering the above equation for X(Sₖ, Bⱼ, t):

$$\vert X ( {S}_{k} , {B}_{j} , t ) \vert \approx \frac{\vert cos ( {az}_{k}^{′} ) \cdot {R}_{x} {B}_{j} \vert}{c \cdot cos ( {el}_{k} )}$$

This approximation may be considered physically to be an equality given the difference in order of magnitude between the distances SₖBⱼ and RₓBⱼ. Hence, it is possible to write the delay of the received signal with respect to the predicted signal as:

$$X ( {S}_{k} , {B}_{j} , t ) = \frac{cos ( {az}_{k}^{′} ) \cdot {R}_{x} {B}_{j}}{c \cdot cos ( {el}_{k} )}$$

### Relative-Azimuth Case:

The relative azimuth

$${az}_{k}^{′} =$$

may be expressed as a function of the azimuth azₖ of satellite Sₖ and of the track heading θ if the receiver Rₓ is located on the same track as the beacon Bⱼ:

$${az}_{k}^{′} = θ - {az}_{k}$$

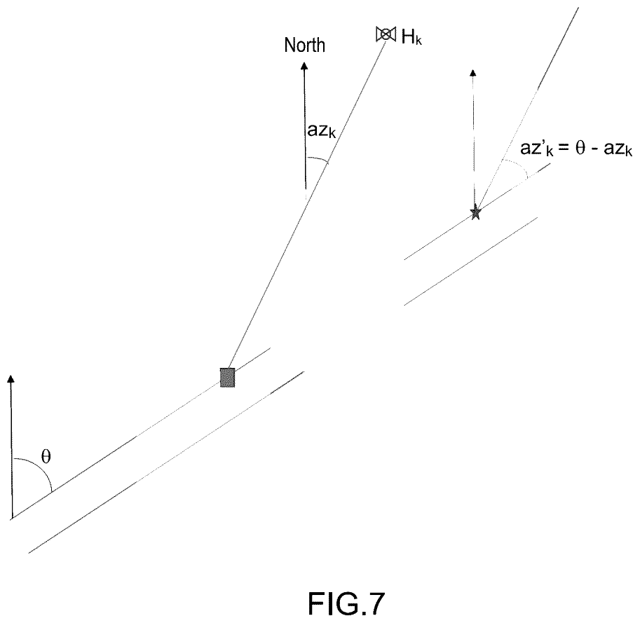

### (see FIG. 7).

$$X ( {S}_{k} , {B}_{j} , t ) = \frac{cos ( θ - {az}_{k} ) \cdot {R}_{x} {B}_{j}}{c \cdot cos ( {el}_{k} )}$$

This expression may be written in the form of a scalar product as follows:

$$X ( {S}_{k} , {B}_{j} , t ) = \frac{cos ( {az}^{′} ) \cdot {R}_{x} {B}_{j}}{c \cdot cos ( el )} = \frac{1}{c} \vec{{B}_{j} {R}_{x}} \cdot \vec{{LOS}_{{S}_{k}}}$$

where LOS_{S}_{ₖ} is the line-of-sight vector, of unitary norm, originating at the beacon Bⱼ (or at the receiver Rₓ, given the distances) and pointing towards satellite Sₖ.

### Measurement Model

The measurement of X(Sₖ, Bⱼ, t) (i.e. the result of the computation performed in step 104 given the received signal) is affected by errors related to prediction of the signal and to the correlator, the errors having a number of sources including:
error in correction/modelling of the propagation of the received signal (ionosphere, troposphere);
satellite errors (satellite clock and orbits) affecting prediction of transmission time and of satellite position;
receiver errors (clock, group delay) affecting estimation of transmission time;
local errors (multipath, spoofing) lengthening the propagation time of the received signal;
correlator sensitivity/resolution and correlation noise.

These errors have different spatial and temporal properties, and influence the value of X(Sₖ, Bⱼ, t) differently.

The errors in ionospheric and tropospheric correction add directly to the difference in geometric trip time, and are locally the same for all the beacons.

By grouping together, on the one hand, receiver-related errors common to all the satellites (b_{rec}), and on the other hand, errors specific to each satellite (orbit, satellite clock, ionospheric and tropospheric model error, multi-path, etc.), which are denoted b_{Sk}, and denoting the measured value \tilde{X}(Sₖ, Bⱼ, t) (i.e. the value computed from the measurements of the received signal and therefore incorporating the errors):

$$\tilde{X} ( {S}_{k} , {B}_{j} , t ) = \frac{1}{c} \vec{{B}_{j} {R}_{x}} \cdot \vec{{LOS}_{{S}_{k}}} + {b}_{rec} + {b}_{Sk}$$

Principles on which the MSP Process is Based

The MSP method is based on the concept of equivalence between the time domain and the spatial/geometric domain.

Below, the delay values X(Sₖ, Bⱼ, t) output in step 104 are considered for the considered set of beacons Bⱼ, j=1 to N, and the considered set of satellites Sₖ, k=1 to r, for a locating time t.

The value of the delay, X(Sₖ, Bⱼ, t), between the received signal and the predicted signal from the satellite Sₖ at a beacon Bⱼ, is a temporal bias; it will be called ΔT_{Bj,Sk}. It may be ‘projected’ and thus converted into a distance in the plane of the paths, which will be called the “spatial bias” ΔS_{Bj,Sk}. This spatial bias is a distance that is a function of the position of the satellite Sₖ in the sky (with an elevation denoted elₖ) and of the speed of light c (on the one hand, the relationship speed=distance/time is used; on the other hand, taking into account a cos (elₖ) applies a correction to allow for the sensitivity of the error to the elevation of the satellite).

The spatial bias is defined by the following equation in the case of a beacon Bⱼ and of a satellite Sₖ:

$$Δ {S}_{Bj , Sk} = \frac{c * Δ {T}_{Bj , Sk}}{cos ( {el}_{k} )}$$

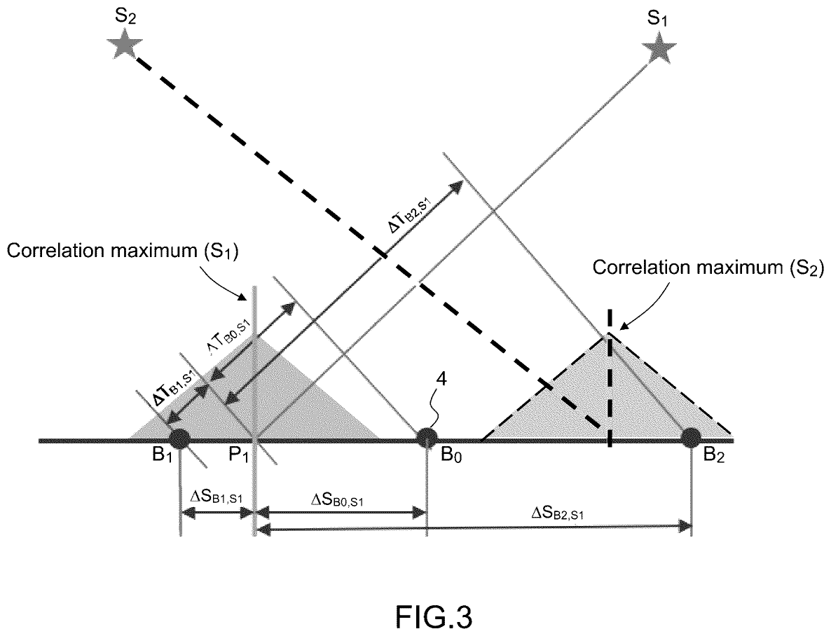

FIG. 3 graphically illustrates this relationship, the train 4 the position of which is being sought being found at B₀. Aspects relating to the satellite S₁ have been drawn with solid lines, and those relating to the satellite S₂ have been drawn with dashed lines.

In FIG. 3:
ΔT_{B1,S1} represents X(S₁, B₁, t) the temporal delay between the maximum correlation for the received signal and the signal predicted for satellite S₁ at beacon B₁;
P1 belongs to the line of maximum correlation of S1, a maximum correlation being measured for S1 at P1, i.e. the delay between predicted signal and received signal is zero;
ΔS_{B1,S1} represents the spatial bias associated with the measured temporal bias ΔT_{B1,S1}.

### MSP Solution

The process implemented in step 105 by the locating unit 121 in accordance with the invention, called the MSP process (it will be recalled that MSP stands for Maximum Spatial Protection), comprises the operation of determining, depending on the determined correlation delays \tilde{X}(Sₖ, Bⱼ, t), at the time t, for i=1 to N and k=1 to s, the beacon closest the receiver to be the one meeting the following conditions:
the beacon must be a distance (spatial bias) less than a predefined threshold from the lines of maximum correlation after correction for a bias that is assumed common to all the satellites;
the beacon must further be the only one of the beacons that is a distance less than the predefined threshold from the lines of maximum correlation, after correction of a bias that is assumed common to all the satellites.

The predefined threshold, which here is denoted MSB_{REF}, is for example set to half the distance D separating two neighbouring beacons (the value of the threshold is considered to be the range of positional protection; for a cold start, to safely determine the track, it must be equal to half the distance between the track and its neighbouring track). In the case considered here MSB_{REF} is equal to 2 m.

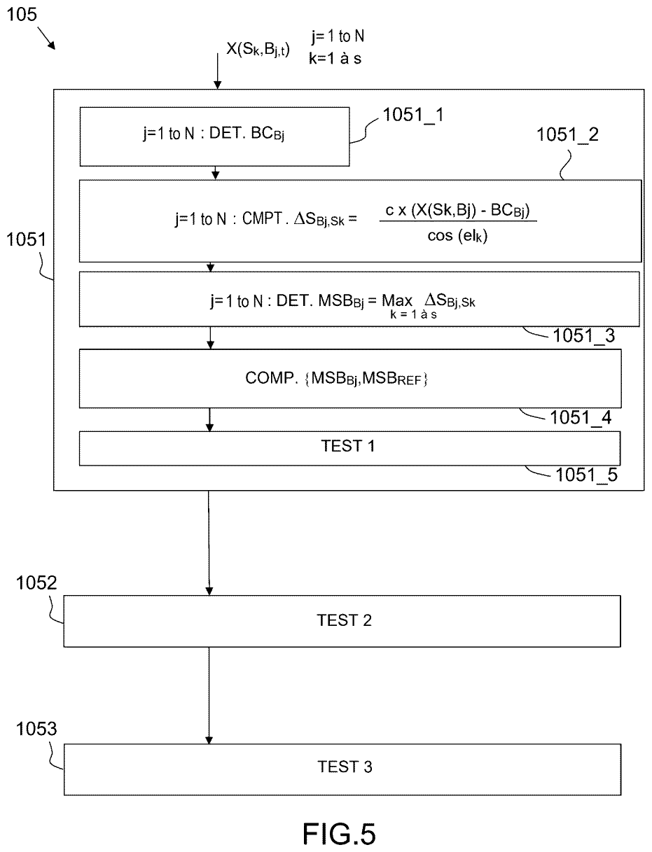

With reference to FIG. 5, in one embodiment of the MSP process executed in step 105, a first test, denoted TEST 1, is carried out in a step 1051.

In this step 1051, the substeps 1051_1 to 1051_5 are implemented by the locating unit 121 (this amounts to studying each hypothesis corresponding to “each beacon is the one at which the receiver 11 is positioned”).

In substep 1051_1, for each beacon Bⱼ considered, the value, denoted BC_{Bj}, of the temporal bias associated with the beacon and common to all the satellites allowing the corresponding residual maximum spatial bias to be minimized is estimated.

In substep 1051_2, for each beacon Bⱼ considered, the residual spatial bias (after correction for the common bias), denoted ΔS_{Bj,Sk} for each satellite Sk, is determined:

$$Δ {S}_{Bj , Sk} = \frac{c * ( Δ {T}_{Bj , Sk} - {BC}_{Bj} )}{cos ( {el}_{k} )} , for k = 1 to s .$$

In substep 1051_3, for each beacon Bⱼ considered, the distance corresponding to the residual maximum spatial bias (after correction for the common bias), denoted MSB_{Bj} (MSB being the abbreviation of Maximum Spatial Bias) is now determined:

$${MSB}_{Bj} = {MAX}_{k = 1 to s} \{ Δ {S}_{Bj , Sk} \}$$

In substep 1051_4, the residual maximum spatial biases MSB_{Bj} of the beacons are compared with the predefined threshold MSB_{REF} (among the set of beacons only one, Bj_pos, is meant to have a residual maximum spatial bias MSB_{Bj_pos} less than MSB_{REF}).

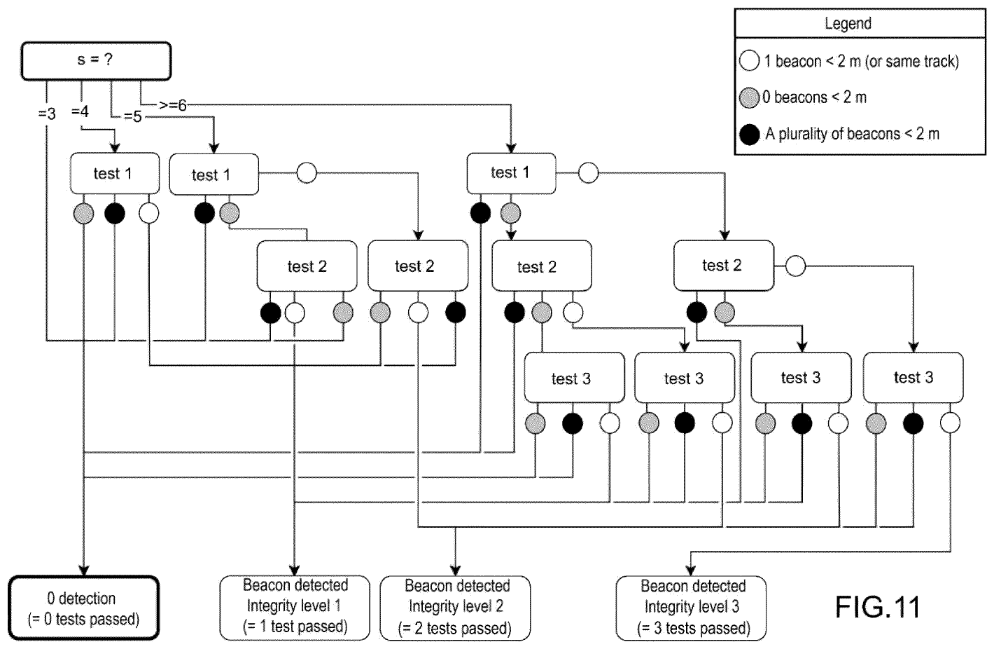

In substep 1051_5, the test TEST 1 is performed, to check whether the correspondence between the detection of bias and the geometry of the topography (database 13) is satisfactory:
if only one beacon, B_{j_pos}, has a residual maximum spatial bias MSB_{Bj_pos} less than MSB_{REF}, this beacon is then considered to be the one at which the receiver 11 is to be found at the time t (situation where the beacon is successfully detected); and in one embodiment, the following test is performed if the number of satellites commonly considered is greater than or equal to 5, to obtain a higher integrity level where appropriate;
if no beacon has a maximum spatial bias MSB_{Bj_pos} less than MSB_{REF}, the position of the receiver 11 cannot be determined in this way (in this case, no beacon is therefore detected); in one embodiment, one or two satellites are considered to be faulty and in one embodiment, the following test is performed if the number of satellites commonly considered is greater than or equal to 5;
in one embodiment, if only two beacons have their maximum spatial bias less than MSB_{REF} and they are adjacent on the same track, it is considered that the train 4 is to be found between the two beacons (this corresponds to the case (inter alia) in the legend in FIG. 11);
in one embodiment, if more than one beacon has a maximum spatial bias less than MSB_{REF} (optionally excluding the case just above): an ambiguous situation is thus detected and it is considered that location is not possible (this situation typically indicates an unsatisfactory satellite distribution).

Various methods may be applied to determine the common bias of substep 1051_1, for beacon Bⱼ. In one embodiment, the common bias BC_{Bj} is set equal to the average, calculated for all the satellites, of the temporal bias associated with beacon Bⱼ:

$${BC}_{Bj} = \frac{1}{s} {\sum }_{k = 1}^{s} Δ {T}_{Bj , Sk} .$$

In another embodiment, all the possible integer values of the common temporal bias are tested (the range of possible values extends from the minimum ΔT_{Bj,Sk} to the maximum ΔT_{Bj,Sk}, among the ΔT_{Bj,Sk}, k=1 to s; for each hypothesis in respect of the common bias, the residual temporal biases are converted into spatial biases; then the maximum spatial bias is retained; subsequently, the algorithm retains the hypothesis in respect of temporal bias that minimizes the maximum spatial bias (MSB_{Bj}).

Substeps 1051_1 and 1051_2 are optional.

In one embodiment of the MSP process, with reference to FIG. 5, the test following TEST 1, denoted TEST 2, is carried out: in a step 1052, steps corresponding to steps 1051_1 to 1051_5 performed above are then repeated, this time considering, one by one, every subgroup of satellites containing one satellite less than the set of satellites considered in steps 1051_1 to 1051_5 of TEST 1.

Furthermore, it is verified whether all these subsets of satellites detect the same beacon as in the previous test where appropriate and, if they do not, the situation is classed as ambiguous and TEST 2 is considered unsuccessful (i.e. location not detected).

If a beacon was not detected in the test of previous level, but a beacon is correctly detected in TEST 2 after exclusion of one satellite, that satellite is considered to be faulty and the detection is considered to be successful with an integrity level of 1.

If no subset meets the 2 m criterion, then the test fails.

In one embodiment of the MSP process, with reference to FIG. 5, another test, TEST 3, is carried out in a step 1053, after step 1052 relating to TEST 2, for s initially considered greater than or equal to 6, and if the result of TEST 2 was detection of zero or of only one beacon with MSB<2 m. The principle is the same as for TEST 2, but the subsets of satellites considered comprise s−2 satellites and no longer s−1 satellites.

A flowchart of an example of a sequence of tests (TEST 1, 2, 3) has been shown in FIG. 11, in one embodiment of the invention, for an MSB_{REF}=2 m.

The MSP solution ensures a protection radius of value MSB_{REF} (here equal to 2 m) around each beacon.

The verification of whether or not the protection-radius criterion (equal to MSB_{REF} here 2 m) is met or not is common to the 3 successive test levels considered in the described embodiment: it aims to verify whether there is indeed one and only one beacon the satellite correlation lines of which are at a distance of less than 2 m (after, in the embodiment considered, correction for bias, which is assumed to be common). Test levels 2 and 3 are variants with the addition of detection consistency for all the subgroups of satellites.

Beacon detection is, in the embodiment described above, associated with an integrity confidence level. Specifically, the MSP process is considered here to be composed of at most 3 successive tests. For each test, there are in fact 3 possible results and not just a binary result (KO or OK); the 3rd result is obtained when none of the beacons is such that its MSB<2 m; in summary:
result 1: “Pass” (=test OK): when there is only one beacon with MSB≤MSB_{REF} or when only two successive beacons (e.g. along the track) have MSB≤MSB_{REF}
result 2: “Ambiguity” (=test KO): when more than two beacons (not corresponding to the preceding case) have MSB≤MSB_{REF}
result 3: “Overflow” (indicating the existence of one or more defective satellites): when none of the beacons has MSB≤MSB_{REF}

In step 1051 of test 1, it is only in this case of the 3rd type of result and in the OK case that test 2 is passed to.

In test 2, the result of the processing must yield the same result for all the subsets of satellites. Each subset that passes will increase detection integrity, processing being continued in Test 3. If ambiguous cases are detected, processing is stopped with integrity level 1. If the result of Test1 was Overflow, if for a subset of s−1 satellites, there is indeed a single beacon with MSB≤MSB_{REF}, this means that one satellite is defective (the one of the s satellites not forming part of this subset of s−1 satellites). Therefore, this is a way of detecting defective satellites. If a defective satellite is detected, the processing continues with performance of Test 3. If, for all the subsets considered in Test 2, >MSB_{REF}, the MSB>this means that there are two faulty satellites, and processing continues with performance of Test 3.

The integrity level of the output solution depends on the number of tiers of tests that were passed (i.e. that gave rise to detection):
integrity level 1 corresponds to 1 test passed;
integrity level 2 corresponds to 2 tests passed (2 tests=OK gives rise to an
integrity level 2; for example, test1=OK; test2=No beacon<2 m and test3=OK)
   if two satellites are faulty, compensate for their errors;
integrity level 3 corresponds to 3 tests passed.

In other embodiments, only one or two of the three tests are considered.

If the number of satellites available is sufficient, the MSP solution in the embodiment implemented here also makes it possible to detect and defend against satellite failure, for example against 1 faulty satellite (test 2) to 2 faulty satellites (test 3).

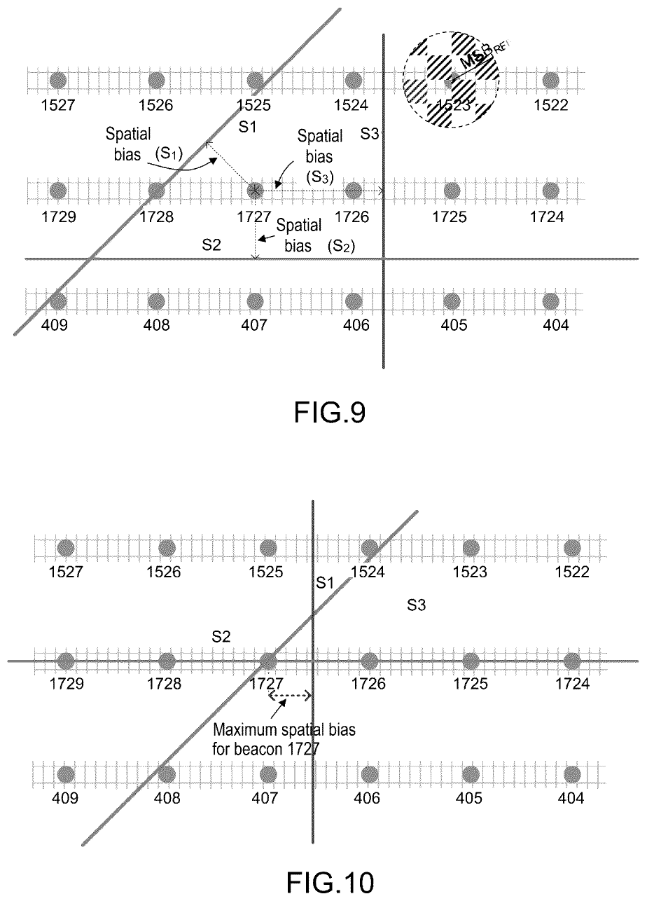

FIG. 9 illustrates determination of spatial biases for a beacon as considered in step 105: the beacon considered is the beacon numbered 1727 and the spatial biases for this beacon relative to each of the satellites S₁, S₂, S₃ have been shown.

The protection radius of size MSB_{REF} has further been shown around the beacon numbered 1523.

FIG. 10 illustrates the maximum spatial bias determined for the beacon numbered 1727 after correction for the common bias, as considered in step 105.

FIGS. 9 and 10 show a bird's eye view of the tracks, the beacons numbered 1522 to 1527 being on one given track, the beacons numbered 1724 to 1729 being on another given track, and the beacons numbered 404 to 409 being on yet another track.

A complete GNSS positioning solution for the rail industry must include the following functionalities:
cold start: recover the initial position of the train with track identification;
main track positioning: positioning the train along the track when it is running on the identified track;
resolve pointing ambiguity: to identify the track used when a set of points is crossed;
retrieve position: retrieve position on departure from a region inaccessible to GNSS, with or without availability of the previous position of the train.

The MSP positioning solution described above was described in the context of a train that was assumed to be stationary (cold start) with, for example, in one embodiment (by way of reminder) the following main steps:
computing, for each beacon considered and each satellite considered, the correlation between the received signals and the predicted signals (steps 101-103);
for each beacon considered, computing the correlation delay (=temporal bias) of the satellite signal for each satellite ΔT_{Bj,Sk}(=X(Sₖ, Bⱼ, t) (step 104);
applying the MSP algorithm (step 105) based on a common error mechanism, with a view to detecting the position of the train and problematic satellites.

In the latter step, an accurate measurement of X(Sₖ, Bⱼ, t) is a prerequisite of satisfactory detection; in the cold-start case, a satisfactorily accurate X(Sₖ, Bⱼ, t) requires the following:
the stationary nature of the train allows a long correlation integration (of up to a few seconds or even minutes), so as to attenuate the impact of noise and allow a stable and reliable correlation result to be obtained;
a list of time shifts predefined with a range small enough to ensure interpolation accuracy.

The method according to the invention described above is configurable to the static case (for consolidation of track detection on start up), to a cold start and to the dynamic case, through configuration of the integration times used in the correlation computations. The time at which a given beacon is passed in the dynamic case could be an additional parameter for refining detection of position. A robust and simple version may do without this by taking into account regular and fixed detection times, and the nearest beacon is thus detected for a position detection time that is also estimated.

Example of finding position when train is moving on a track (dynamic case):

In such a case, in one embodiment, only beacons of the database 13 that are identified, therein, as being located on running tracks (or a subset of these beacons) are considered when implementing the algorithm 100 (the size of this subset may be further decreased by retaining only beacons located on tracks on which the train is likely to be located, this assessment being made, for example, depending on a maximum movement evaluated based on the measurements of an on-board inertial measurement unit and on a previous reliable position of the train). These subsets of beacons are therefore, in this case, the beacons Bᵢ, i=1 to N considered.

In one embodiment, the dynamic case differs from the static case in that, furthermore, the correlation is computed at various times, the correlation being maximum at the moment when the train is next to the beacon. Specifically, in addition to beacon detection (maximum spatial correlation), it is also necessary to detect the time at which this correlation is maximum (which is not necessary in the static case).

### Dynamic Positioning:

### Dynamic Correlation Integration Time:

When the train is in motion, the received GNSS signal is collected by the receiver Rx 11 from various positions. For the received GNSS signals, in addition to the impact of noise/interference, a new ambiguity in the position of collection of the signal is thus introduced.

An appropriate correlation integration time must be suitably defined to balance the following aspects:
the duration of the integration time must be as long as possible to attenuate the impact of noise in order to obtain a sufficiently accurate correlation result;
the duration of the integration time must be as short as possible to reduce ambiguity in the position of collection of the signal.

In parallel, on account of the fact that positioning is dynamic, in order to resolve pointing ambiguities and to determine the position of the moving train, it is generally necessary to distinguish between tracks, hence the signal collection range threshold value is defined as 2 metres, i.e.:

$$correlation integration time Tint = 2 m / Vtrain ( Vtrain : train speed )$$

According to the above formula, the typical integration time is: 1.3 s for 5 km/h, 400 ms for 20 km/h, 120 ms for 60 km/h, 60 ms for 120 km/h, 40 ms for 180 km/h.

As summarised above, with a dynamic correlation integration time, the same algorithm may be used for dynamic positioning.

Track detection when the train is moving:

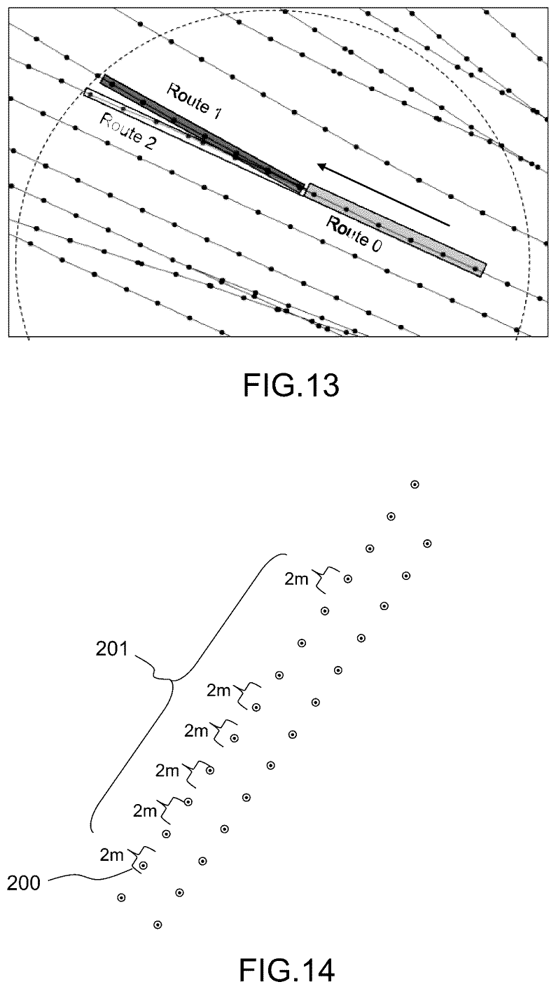

Sometimes, signals of several tens of milliseconds are not enough to attenuate the impact of noise. In one embodiment, the following method is implemented by the locating unit 121 to further attenuate random signal error by averaging MSP information:
the beacons considered and their associated positions defined in the database (the beacons considered correspond only to candidate positions in one embodiment, these for example being limited to beacons within a circle of uncertainty such as 100 metres around the PVT position of the train) are grouped together into various paths (routes) near the localised track (in other words, possible positions are only sought with respect to a reliably known/track position) as illustrated in FIG. 13, which shows part of a circle of uncertainty, beacons (small circles) grouped into routes numbered 0, 1 and 2, and an arrow indicating the direction of movement to be determined;
correlation is computed (step 103) for the beacons considered with a defined integration time;
for each considered beacon Bᵢ, the correlation delay ΔT_{Bj,Sk}=X(Sₖ, Bⱼ, t) is computed for each satellite;
for each possible route (route k):
the beacon with a minimum maximum spatial bias (MSB) is determined and is defined as the most likely position on the route;
for this most probable position (corresponding to beacon Bⱼ₀ᵣₒᵤₜₑₖ), the spatial bias relative to each satellite ΔS_{Bj0 route k,Sk}, k=1 to s, is recorded and averaged over the last N measurement times considered: see the illustration in FIG. 14, the current detection is referenced 200, the last N detections have been indicated by the brace referenced 201;
among the above average spatial biases of each satellite, the maximum one is chosen, which is then defined as the MSB of the route;
on this basis decision-making logic analogous to the MSP method (step 105 described above) is applied to determine the new track after crossing a set of points (here, only when the possible routes are again at least 4 m apart):
there must be only one MSB below the threshold (defined as half the distance between 2 tracks (typically 2m)); this MSB will be retained as the true route;
if no MSB meets the threshold defined as half the distance between 2 routes, then the track cannot be solved and it is necessary to wait for the next iteration;
if 2 or more MSBs satisfy the threshold, then the situation is ambiguous (due to biased satellites): the track cannot be solved; the test is performed in the following iteration.

The method may be used to detect track to resolve pointing ambiguity, and to distinguish track for train movement. It may also be used to improve the integrity of the positioning of the main track with the determined track.

Alternative Solutions for Determining Delay Values X(Sₖ, Bᵢ, t)

There are various solutions for determining the delay values X(Sₖ, Bᵢ, t).

One of these solutions was described in steps 101 to 104 considering the beacon Bᵢ and all the satellites Sₖ, k=1 to s, in which solution the correlation of the signals received and theoretically received at Bᵢ is computed, and the delay X(Sₖ, Bᵢ, t) is deduced from the computed correlation. Typically, if P possible positions (i.e. P beacons), S satellites and 5 time shifts for the correlation are considered, then there will be P*S*5 correlation points to compute (with, for each correlation point, a computation of the predicted code and of the correlation with the signal actually received), then, for each position and each satellite, a delay Xmax is computed based on the correlation result of 5 time shifts using a parabolic interpolation: thus a large volume of computations is carried out.

In one embodiment, the invention implements, instead, a solution for determining the delay values X(Sₖ, Bᵢ, t) according to one of the two approaches described below, exploiting the relationship between the delays relative to one beacon and the delays relative to another beacon, thus allowing the correlation to be computed only for a reference beacon.

Two approaches are proposed here.

### Approach 1:

The correlation computed relative to one of the beacons, for example the beacon B₁, for satellite Sₖ, may be expressed as follows:

$${\int }_{T 0}^{T 0 + Tint} {c}_{RX , Sk} ( t ) \cdot {c}_{cmpt B 1 , Sk} ( t ) \cdot dt$$

It follows that between two beacons, B₁, B₂, the correlation difference is simply the difference in the predicted signals c_{cmpt B1,Sk}(t), c_{cmpt B2,Sk}(t), as all the beacons use the same error correction for the predicted signals of Sₖ, thus:

$${c}_{cmpt B 1 , Sk} ( t ) - {c}_{cmpt B 2 , Sk} ( t ) = \frac{1}{c} ( {S}_{k} {B}_{1} - {S}_{k} {B}_{2} )$$

where c is the speed of light in vacuum; and where SₖB₁ and SₖB₂ are the distance between satellite Sₖ and beacon B₁, and the distance between satellite Sₖ and beacon B₂, respectively.

Using this approach, the locating unit 121 determines the delay X(Sₖ, Bᵢ, t) of any beacon Bᵢ by “translation”, instead of implementing steps 101 to 104, based on the delay determined for a reference beacon Bₒ:

$$X ( {S}_{k} , {B}_{i} , t ) = X ( {S}_{k} , {B}_{0} , t ) + \frac{1}{c} ( {S}_{k} {B}_{i} - {S}_{k} {B}_{0} ) ,$$

where Sₖ Bₒ and SₖBᵢ are the distance between satellite Sₖ and beacon B₀, and the distance between satellite Sₖ and beacon Bᵢ, respectively.

### Approach 2:

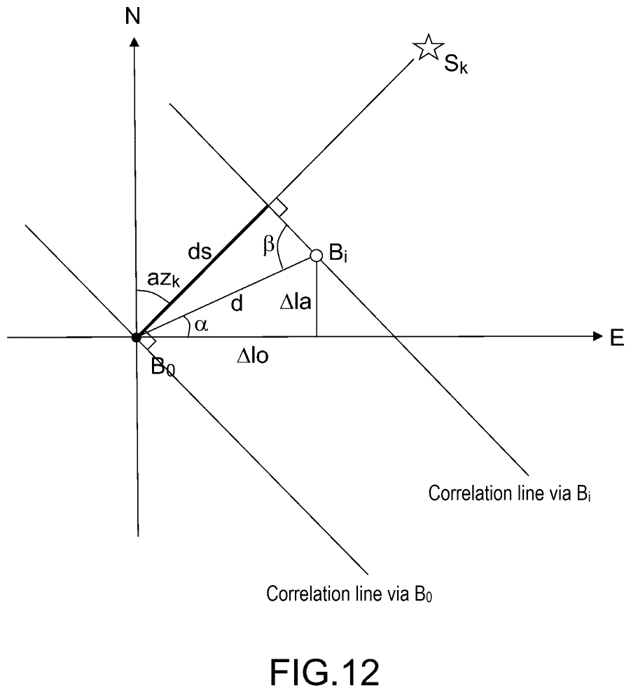

This approach 2 is based on the notion of correlation line. According to the correlation formula, at positions (i.e. between beacons) that are at the same distance from the satellite Sₖ, the predicted signal is the same and therefore the same correlation result is obtained. These positions (beacons) are on the same line on the ground, which is called the correlation line. The difference between the delays relative to any two beacons is in fact the distance between the correlation lines on which the two beacons are located. FIG. 12, illustrates, among the set of points signalling beacon positions, the correlation line on which beacon B₀ is located and the correlation line on which another beacon Bᵢ is located, and the distance, ds, between these two correlation lines.

Using this approach, instead of steps 101 to 104, the locating unit 121 determines the delay X(Sₖ, Bᵢ, t) of any given beacon Bᵢ by “translation” based on the delay determined for a reference beacon B₀ using the following formula

$$X ( {S}_{k} , {B}_{i} , t ) = X ( {S}_{k} , {B}_{0} , t ) + ds * cos ( {el}_{k} ) / 0.3$$

where:
azₖ and elₖ are the azimuth angle and elevation angle of satellite Sₖ, respectively;
α is the angle between the straight line passing through B₀ and Bᵢ and the axis E;
β is the angle between the straight line passing through B₀ and Bᵢ and the correlation line passing through Bᵢ;
d is the distance between the beacons B₀ and, Bᵢ;
ds is the distance, along the line of satellite Sₖ in the plane, between beacons B₀ and Bᵢ (in other words, it is the projection of d along SₖB₀),
the following computations being performed:
Δla=latitude(B₀)−latitude(Bᵢ), Δlo=longitude(B₀)−longitude (Bᵢ), the coordinates referred to as longitude( ) and latitude( ) of the beacons B₀ and Bᵢ being given in a NED coordinate system (or in any orthogonal coordinate system also in the local tangent plane);

$$α = arc tan ( Δ la / ( Δ lo * cos ( latitude ( {B}_{0} )$$

$$β = {az}_{k} + α$$

$$ds = d * sin ( β )$$

$$and lastly : X ( {S}_{k} , {B}_{i} , t ) = X ( {S}_{k} , {B}_{0} , t ) + ds * cos ( {el}_{k} ) / 0.3 .$$

Implementation of either of these two approaches makes it possible to substantially decrease the computational load required to implement the locating solution according to the invention.

Tests have been carried out using real signals collected from tracks, allowing correlation delay X( ) to be deduced for seven beacons by “translation” from another reference beacon. The difference between the delays obtained by translation and those actually measured by computation of correlation was calculated: it was about 0.1 m on average and at most 0.39 m and the two approaches gave comparable results with an average difference of 0.02 m and a maximum difference of 0.1 m.

Moreover, it is necessary to use accurate values for the correlation delays in the locating solution according to the invention. However, the accuracy of the correlation delay X( ) obtained based on correlation computations using measurements of received signals and computation of theoretical signals at the beacons is unknown. Inaccuracy may result from noise or interference in the GNSS signal and/or interpolation errors.

The translated correlation delay values may be used to evaluate the accuracy of “measured” correlation delays and to validate/invalidate satellites: see the two examples of embodiments described below.

For example, considering two beacons B₀₁ and B₀₂ (here 13.5 m apart), the “measured” X(Sₖ, Bᵢ, t), i=01, 02, is determined by actually computing correlation (using measurements at these beacons) relative to these beacons, by implementing steps 101 to 104.

In a first validation mode, the comparison of the correlation delays at one or more beacons obtained by translation (using one of the two approaches described above) and the correlation delays actually “measured” at these beacons (in steps 101 to 104) is used to evaluate the accuracy of “measured” correlation delays and to validate/invalidate satellites. Starting with the X(Sₖ, Bᵢ, t) thus computed (measured), i=01, this time by translation from the reference beacon Bot, a translated X(Sₖ, Bⱼ, t)ᵢ₌₀₂ is determined. The differences between the measured and translated X(Sₖ, Bⱼ, t)₀₂ are then compared, and if the difference exceeds a predetermined threshold, Sₖ is excluded from the set of satellites used by the locating unit 121 to determine location in step 105.

In a second validation mode, each of the beacons B₀₁ and B₀₂ is used as reference beacon by the locating unit 121 to compute, by translation, using one of the two approaches described above, the correlation delay X(Sₖ, Bⱼ, t), j=1 to r.

Next, for each beacon Bⱼ, j=1 to r, the locating unit 121 obtains a first value X(Sₖ, Bⱼ, t)₀₁ by translation from the measured X(Sₖ, B₀₁, t) and a second value X(Sₖ, Bⱼ, t)₀₂ by translation from the measured value X(Sₖ, B₀₂, t). The differences between the translated X(Sₖ, Bⱼ, t)₀₁ and X(Sₖ, Bⱼ, t)₀₂ are then compared, j=1 to r, and if the difference exceeds a predetermined threshold (specific to satellite Sₖ or common to various satellites), Sₖ is excluded from the set of satellites used by the locating unit 121 to determine location in step 105.

It will moreover be noted that measurement of codes in positioning signals was described above. The invention may also be implemented by measuring, instead or in addition to measurement of codes, the phases of the carriers of the positioning signals.

The method 100 may be implemented by executing software instructions on a processor, as described above. Alternatively, any one may be implemented by dedicated hardware, typically a digital integrated circuit, either an application-specific integrated circuit (ASIC) or a circuit based on programmable logic (for example an FPGA/Field-Programmable Gate Array).

The method according to the invention may of course be used, in sectors other than the railway sector, in any system in which it is necessary to estimate the position of a machine that is able to move only over a predetermined and finite set of paths, a database storing the geopositions of virtual beacons located on the paths.

1. A method for locating a machine configured to move over a set of one or more predefined paths (V1, V2),
a satellite receiver located on board the machine being configured to receive, at a time t, geopositioning signals from a system of satellites comprising at least s satellites Sk, k=1 to s and s greater than or equal to 3;
an electronic processing unit comprising a database storing the geographical coordinates Pj of virtual beacons Bj, j=1 to N, distributed along the paths of said set of one or more paths;
said method comprising the following steps implemented by the electronic processing unit at a locating time t:
i1/ for each beacon Bj, j=1 to N:
for each satellite Sk for k=1 to s:
computing the delay between the geopositioning signal received by the satellite receiver at the time t from satellite Sk and the theoretical geopositioning signal that should, according to computations, have been received from satellite Sk at the time t at the position of virtual beacon Bi such as defined by the geographical coordinates Pj of Bj in the database, said delay being called the correlation delay, X(Sₖ, Bⱼ);
a value representative of the correlation delay X(Sₖ, Bⱼ) is converted into a corresponding distance, ΔS_{Bj,Sk}, called the spatial bias, by multiplying this value representative of the correlation delay X(Sₖ, Bⱼ) by c, the speed of light in vacuum, and dividing it by cos elₖ, where elₖ is the elevation of satellite Sk;
for each beacon Bj, j=1 to N, a maximum spatial bias MSB_{Bj} is determined:
$${MSB}_{Bj} = {MAX}_{k = 1 to s} \{ Δ {S}_{Bj , Sk} \}$$
i2/ the maximum spatial biases MSB_{Bj}, j=1 to N, are compared with a predefined threshold MSB_{REF}: according to this comparison, if only one beacon has a maximum spatial bias MSB_{Bj} less than MSB_{REF}, this beacon is then detected as the one at which the machine is to be found at the locating time.

2. The locating method according to claim 1, wherein one of the following measures is further implemented by the processing unit in step i2:
i2_1/ if only two beacons have their maximum spatial biases less than MSB_{REF} and they are adjacent on the same track, it is considered that the machine is between the two beacons;
i2_2/ if more than one beacon has a maximum spatial bias less than MSB_{REF} (optionally excluding the case just above): an ambiguous situation is detected and it is considered that location is not possible;
i2_3/ if only two beacons have their maximum spatial bias less than MSB_{REF} and they are adjacent on the same track, it is considered that the machine is to be found between the two beacons; excluding this case, if more than one beacon has a maximum spatial bias less than MSB_{REF}, it is considered that location is not possible;
i2_4/ if no beacon has a maximum spatial bias less than MSB_{REF}, this indicates the existence of defective satellites, an ambiguous situation is thus detected and it is considered that location is not possible.

3. The locating method according to claim 1, wherein steps i1 and i2 are iterated relative to each subset of satellites containing s−1 of the s satellites instead of the s satellites considered in the previous iteration for s≥5, when, according to said comparison of the previous iteration, only one beacon has a maximum spatial bias MSB_{Bj} less than MSB_{REF} and
if, in the current iteration, for each of the subsets of satellites, the comparing step detects the same single beacon as the previous iteration, corresponding to a given integrity level, said beacon is considered to be detected with said given integrity level increased by one.

4. The locating method according to claim 1, wherein steps i1 and i2 are iterated relative to each subset of satellites containing s−1 of the s satellites instead of the s satellites considered in the previous iteration for s≥5, and if in the previous iteration, no beacon had a maximum spatial bias MSB_{Bj_pos} less than MSB_{REF} and in the current iteration, a single beacon has a maximum spatial bias MSB_{Bj} less than MSB_{REF}, this beacon is then detected as the one at which the machine is to be located at the locating time and the s^{th} satellite is identified as faulty.

5. The locating method according to claim 1, wherein said value representative of the correlation delay X(Sₖ, Bⱼ) is equal to the difference between said correlation delay X(Sₖ, Bⱼ) and a bias, called BC_{Bj}, that is an estimate of the temporal bias associated with beacon Bj and common to all the satellites and allowing MSB_{Bj} to be minimized.

6. The locating method according to claim 1, wherein said value representative of the correlation delay X(Sₖ, Bⱼ) is equal to the difference between said correlation delay X(Sₖ, Bⱼ) and a bias called
$${BC}_{Bj} = \frac{1}{s} {\sum }_{k = 1}^{s} X ( {S}_{k} , {B}_{j} ) .$$

7. The locating method according to claim 1, wherein the processing unit implements one of the following measures i1a, i1b, i1c, in order, considering beacon Bi, to implement step i1 of computing delays, X(Sₖ, Bᵢ, t) for k=1 to s:
i1a/ computing the correlation between said received geopositioning signal and said theoretical geopositioning signal computed for Bᵢ, said delay X(Sₖ, Bᵢ, t) being computed depending at least on said computed correlation;
i1b/ the delay X(Sₖ, Bᵢ, t) is computed by translation, using the following formula:
$$X ( {S}_{k} , {B}_{i} , t ) = X ( {S}_{k} , {B}_{0} , t ) + \frac{1}{c} ( {S}_{k} {B}_{i} - {S}_{k} {B}_{0} ) ,$$
where
Sₖ B₀ and SₖBᵢ are the distance between satellite Sₖ and a reference beacon B₀, and the distance between satellite Sₖ and beacon Bᵢ, respectively,
X(Sₖ, B₀, t) is the delay between the geopositioning signal received by the satellite receiver at the time t from satellite Sₖ and the theoretical geopositioning signal that should, according to computations, have been received from satellite Sₖ at the time t at the position of virtual beacon B₀ such as defined by the geographical coordinates P0 of B₀ in the database
c is the speed of light in vacuum;
i1c/ the delay X(Sₖ, Bᵢ, t) is computed by translation, using the following formula:
$$X ( {S}_{k} , {B}_{i} , t ) = X ( {S}_{k} , {B}_{0} , t ) + ds * cos ( {el}_{k} ) / 0.3$$
where B₀ is a reference beacon,
$$Δ la = latitude ( {B}_{0} ) - latitude ( {B}_{i} ) , Δ lo = longitude ( {B}_{0} ) - longitude ( {B}_{i} ) α = arc tan ( Δ la / ( Δ lo * cos ( latitude ( {B}_{0} ) ) )$$
$$β = {az}_{k} + α$$
$$ds = d * sin ( β )$$
where latitude( ), longitude( ) are coordinates in an orthogonal coordinate system in the local tangent plane.

8. The locating method according to claim 7, wherein the processing unit implements at least one of the following measures 4.1, 4.2:
4.1 by implementing measure i1a, X(Sₖ, B₀₁, t) and X(Sₖ, B₀₂, t) are computed; then, considering B₀₁ as reference beacon and implementing one of the formulas in i1b or i1c, the delay for B₀₂ is determined this time by translation considering B₀₁ as reference beacon and is called X(Sₖ, B₀₂, t)₀₁;
and, depending at least on the difference between X(Sₖ, B₀₂, t) and X(Sₖ, B₀₂, t)₀₁, the satellite Sₖ is excluded from the set of satellites taken into consideration for step i3 of estimating the location of the machine depending on said values representative of discrepancies between said computed delays;
4.2 performing the following step for beacons Bi, i=1 to r:
by implementing one of the formulas in i1b or i1c: a first delay X(Sₖ, Bᵢ, t)₀₁ is determined considering B₀₁ as reference beacon and a second delay X(Sₖ, Bᵢ, t)₀₂ is determined considering B₀₂ as reference beacon;
and, depending at least on the difference between X(Sₖ, Bᵢ, t)₀₁ and X(Sₖ, Bᵢ, t)₀₂, i=1 to r, the satellite Sₖ is excluded from the set of satellites taken into consideration for step i3 of estimating the location of the machine depending on said values representative of discrepancies between said computed delays.

9. The locating method according to claim 1, wherein each beacon considered is spaced apart from its nearest neighbours by a distance D equal to the distance between two neighbouring tracks and the predefined threshold MSB_{REF} is set equal to D/2.

10. A computer program, intended to be stored in the memory of an electronic locating device further comprising a microcomputer, said computer program comprising instructions that, when they are executed on the microcomputer, implement the steps of a method according to claim 1.

11. An electronic processing unit for locating a machine that is configured to move over a set of one or more predefined paths (V1, V2) and that has on board it a satellite receiver for receiving, at a time t, geopositioning signals from a system of satellites comprising at least s satellites Sk, k=1 to s and s greater than or equal to 3;
the electronic processing unit comprising a database storing the geographical coordinates Pj of virtual beacons Bj, j=1 to N, distributed along the paths of said set of one or more paths;
said electronic processing unit being configured to implement the following operations, at a locating time t:
i1/for each beacon Bj, j=1 to N:
for each satellite Sk for k=1 to s:
computing the delay between the geopositioning signal received by the satellite receiver at the time t from satellite Sk and the theoretical geopositioning signal that should, according to computations, have been received from satellite Sk at the time t at the position of virtual beacon Bi such as defined by the geographical coordinates Pj of Bj in the database, said delay being called the correlation delay, X(Sₖ, Bⱼ);
a value representative of the correlation delay X(Sₖ, Bⱼ) is converted into a corresponding distance, ΔS_{Bj,Sk}, called the spatial bias, by multiplying this value representative of the correlation delay X(Sₖ, Bⱼ) by c, the speed of light in vacuum, and dividing it by cos elₖ, where elₖ is the elevation of satellite Sk;
for each beacon Bj, j=1 to N, a maximum spatial bias MSB_{Bj} is determined:
$${MSB}_{Bj} = {MAX}_{k = 1 to s} \{ Δ {S}_{Bj , Sk} \}$$
i2/ the maximum spatial biases MSB_{Bj}, j=1 to N, are compared with a predefined threshold MSB_{REF}: according to this comparison, if only one beacon has a maximum spatial bias MSB_{Bj} less than MSB_{REF}, this beacon is then detected as the one at which the machine is to be found at the locating time.
